(19) United States
(12) Patent Application Publication
(10) Pub. No.: US 2010/0082405 A1
(43) Pub. Date: Apr. 1, 2010

(54) Multi-period-ahead Forecasting

(76) Inventor: Jerry Z. Shan, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/242,646

(22) Filed: Sep. 30, 2008

(51) Int. Cl. G06Q 10/00

(52) U.S. Cl. 705/10

(57) ABSTRACT

Embodiments include methods, apparatus, and systems for multi-period-ahead forecasting. One embodiment is a method that applies a first forecasting algorithm to static historical data to generate a first forecast into a future time period and applies a second forecasting algorithm to dynamic data obtained for a current time period to generate a second forecast. The first and second forecasts are combined to generate forecasts for future time periods.

### BACKGROUND

Successful competition in a commercial enterprise often requires careful monitoring of profit margins, sales, deadlines, and many other types of business information. Businesses rely on their performance information to support strategic planning and decision making. Businesses without a system for providing accurate and timely forecasts of business information have large disadvantages relative to their competitors.

Accordingly, businesses often use computerized data to forecast events and outcomes, such as end-of-quarter revenue, end-of-month inventory, or end-of-year overhead costs. Forecasts are also used to monitor the probability of achieving some goal to support current business decisions. These tasks are quite challenging to model, especially in large commercial enterprises with large numbers of complex and ongoing transactions.

Some traditional methods forecast events using historical data. For example, a traditional method to forecast monthly revenue is to use actual revenue from previous months that are already closed and completed. Models applied to such data have limited accuracy since the forecasts are based on prior static information.

### BRIEF DESCRIPTION OF THE DRAWINGS

FIG. 1 is a flow diagram for providing multi-period-ahead dynamic forecasting in accordance with an exemplary embodiment.

FIG. 2A is a graph of a one-month-ahead dynamic prediction algorithm in accordance with an exemplary embodiment.

FIG. 2B is a graph of a two-month-ahead dynamic prediction algorithm in accordance with an exemplary embodiment.

FIG. 3 is a block diagram of a computer for executing methods in accordance with an exemplary embodiment.

### DETAILED DESCRIPTION

Exemplary embodiments are directed to apparatus, systems, and methods for multi-period-ahead dynamic forecasting. Embodiments provide a dynamic or updatable forecast for dynamic multi-period-ahead forecasts for a given time period. One embodiment provides a forecasting solution that makes not only one-month-ahead dynamic forecasts but also multi-period-ahead dynamic forecasts. Exemplary embodiments are useful for addressing long-range forecasting needs, such as in financial analysis or long lead time supply chain planning.

For illustration purposes, embodiments are discussed using monthly forecasts, but one skilled in the art appreciates that exemplary embodiments are applicable to a wide variety of forecasting time periods, such as minutes, hours, days, weeks, months, years, etc.

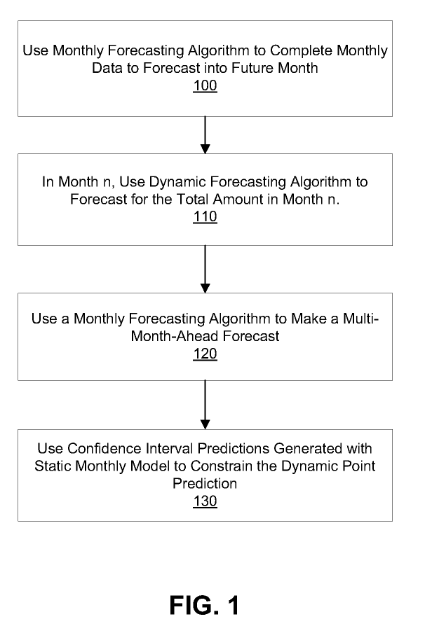

FIG. 1 is a flow diagram for providing multi-period-ahead dynamic forecasting in accordance with an exemplary embodiment. The time period or term monthly describes a highly granularity level, and the time period or term daily describes relatively a lower granularity level. The higher granularity level is readily adaptable to any period (such as quarterly, half yearly, and yearly, etc.), and the lower granularity level (for example, a daily notion) is any level below the higher granularity level (such as hourly, weekly, etc.).

By way of example, suppose an enterprise desires to forecast events or outcomes for one or more future months. Further, suppose we are within the month n, with daily observations up to somewhere in the month. Also, suppose we have all the historical data (daily and monthly) up to month n−1 available. Exemplary embodiments provide a forecast into one or more future months. In other words, forecasts are provided for month n+k, where k is any non-negative integer or number (such as 0, 1, 2, 3, etc.). When k=0, the forecast is for the current month n, made with historical data observations up to month n−1, the last month before the current month.

According to block 100, a monthly forecasting algorithm is used on the complete monthly data to forecast into a future month. For illustration, Aᵢ denotes the actual data for month i. When in month n, we have A₁, A₂, . . . , Aₙ₋₁. Exemplary embodiments use a monthly forecasting algorithm such as Holt-Winters algorithm or an ARIMA (Auto-Regressive Integrated Moving Average) model to make a 1-step-ahead (that is month n), a 2-step-ahead (that is month n+1), or other multi-month-ahead forecast.

The monthly forecasting algorithms used in block 100 are static. In other words, these algorithms will not change or get updated as data for the current month is received. Thus, such algorithms do not utilize daily observations in the current month n.

For illustration, SFₙ₊ₖ denotes the monthly static point forecast for month n+k. With a confidence level specification, exemplary embodiments also get a confidence interval prediction for month n+k. These confidence interval predictions are denoted by SFUₙ₊ₖ, and SFLₙ₊ₖ, respectively for the upper bound and lower bound, both of which are static.

According to block 110, in month n, a dynamic forecast algorithm is used to forecast the total amount in month n. By way of example, one such dynamic forecast algorithm is a Bayesian dynamic forecast algorithm described in U.S. patent application entitled “Method and Systems for Cumulative Attribute Forecasting Using a PDF of a Current-to-Future Value Ratio” having Ser. No. 10/959,861, filed Oct. 6, 2004 and incorporated herein by reference.

With the daily data observed so far in month n, exemplary embodiments calculate a forecast Fₙ for the month. This forecast is dynamic and gets updated daily. In other words, as new data is received or observed during the month n, this data is used in the forecast. Exemplary embodiments enable updates to be provided and used on different time periods, such as daily, hourly, every minute, continuously, etc. For illustration, denote by DFₙ the generated dynamic forecast for month n.

According to block 120, exemplary embodiments use a monthly forecasting algorithm model to make a multi-month-ahead forecast, with the input time series data {A₁, A₂, . . . , Aₙ₋₁, DFₙ}. Examples of such forecasting algorithms include, but are not limited to ARIMA and Holt-Winter algorithms. For illustration, denote by DFₙ₊ₖ the dynamic point forecast for month n+k generated this way, for k≧1. In one exemplary embodiment, DFₙ₊ₖ is dynamic since the underlying input data contains a dynamic component, which is DFₙ, which changes every day in month n.

According to block 130, the confidence interval predictions generated with the static monthly model in block 100 are used to constrain the dynamic point prediction obtained in block 120. Specifically, for a future month n+k, if DFₙ₊ₖ is above the upper bound SFUₙ₊ₖ, or below the lower bound SFLₙ₊ₖ, then use the corresponding bound value as the final point prediction. If DFₙ₊ₖ is within the interval (i.e., the bounds), then use DFₙ₊ₖ as the final point prediction. The bounding step insures less variability for the forecasts. Note that when k=0, the original dynamic point forecast DFₙ₊ₖ=DFₙ, which is produced in above using the daily dynamics in the forecast month n, may not be completely the same as the bounded dynamic forecast DFₙ₊ₖ=DFₙ, which is produced with the additional bounding step. As mentioned in herein, for the purpose of the reduced forecast variability, we use the bounded dynamic point forecast DFₙ, which provides an improved methodology.

Exemplary embodiments provide a forecasting solution that generates forecast for a multi-period-ahead period. Further, forecasts are dynamically updatable in real-time as incremental new information in a current period is generated and received. The daily forecast is also contained in a reasonable range obtained from a static monthly model, and hence is not subject to the large variability stemmed from the few observations within the current period in the early stage of dynamic updating.

Exemplary embodiments provide a multi-period-ahead forecasts that include the current time (for example, month) in which the forecast is being performed. Further, such forecasts provide updating beyond the current forecast period (for example, into future months beyond the current month).

Once the forecasting solution is generated, it can be used in a variety of ways. By way of example, forecasts for a multi-period-ahead period are displayed on a computer, transmitted over one or more networks, used in computational analysis or system, and/or delivered to a client through a web service (such as software systems used to support interoperable machine to machine interaction over a network).

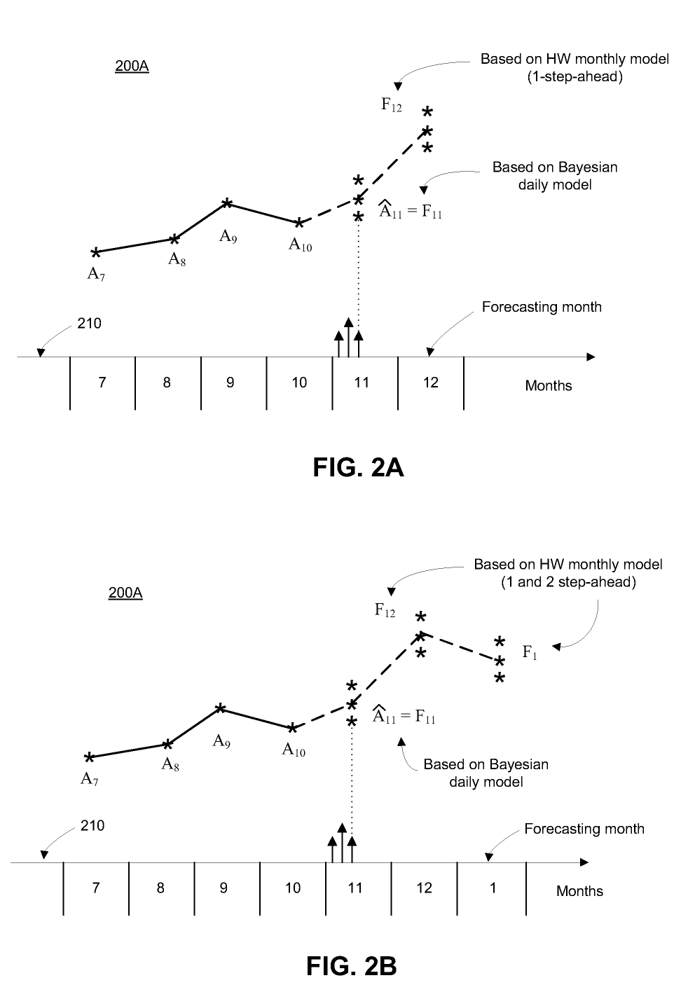

FIG. 2A is a graph 200A of a one-month-ahead dynamic prediction algorithm in accordance with an exemplary embodiment. For illustration, a plurality of time series data entries (A₇, A₈, A₉, etc.) are shown for multiple months (7, 8, 9, etc.). The months are depicted along an x-axis 210 and include times series data entries up to the last completed month (shown as month 10). Exemplary embodiments utilize the observed daily data in the current month (shown as month 11) to project or forecast the monthly total (shown as A₁₁) that represents the total amount to be covered in all days in the month. The forecast for this point (shown as Â₁₁=F₁₁) can be provided by a Bayesian daily dynamic model as cited in [0015] or other dynamic models. Using the predictive forecasting algorithms, exemplar embodiments predict or forecast one month ahead of the current date and time (shown as F₁₂). By way of example, this point is based on forecasts from Holt-Winters (HW) algorithm.

FIG. 2B is a graph 200B of a two-month-ahead dynamic prediction algorithm in accordance with an exemplary embodiment. For illustration, a plurality of time series data entries (A₇, A₈, A₉, etc.) are shown for multiple months (7, 8, 9, etc.). The months are depicted along an x-axis 210 and include times series data entries up to the last completed month (shown as month 10). Exemplary embodiments utilize observed daily data for the current month (shown as month 11) to project or forecast the monthly total (shown as A₁₁) that represents the total amount to be covered in all days in the month. The forecast for this point Â₁₁=F₁₁ can be based on a Bayesian daily model or other dynamic models. Using the predictive forecasting algorithms, exemplar embodiments predict or forecast several months ahead of the current date and time (shown as F₁₂ and F₁ which represent forecasts for month 12 and its subsequent month 1, which is in the next year). By way of example, these points are based forecasts from on Holt-Winters (HW) algorithm.

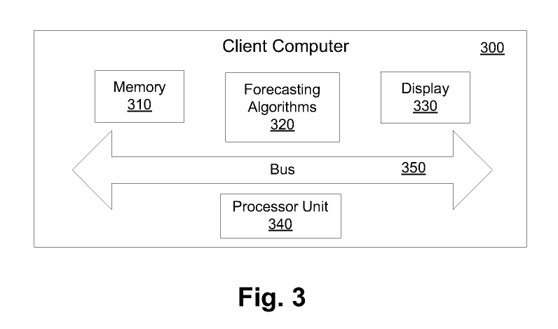

FIG. 3 is a block diagram of a client computer or electronic device 300 in accordance with an exemplary embodiment of the present invention. In one embodiment, the computer or electronic device includes memory 310, forecasting algorithms 320, display 330, processing unit 340, and one or more buses 350.

In one embodiment, the processor unit includes a processor (such as a central processing unit, CPU, microprocessor, application-specific integrated circuit (ASIC), etc.) for controlling the overall operation of memory 310 (such as random access memory (RAM) for temporary data storage, read only memory (ROM) for permanent data storage, and firmware). The processing unit 340 communicates with memory 310 and forecasting algorithms 320 via one or more buses 350 and performs operations and tasks necessary to provide dynamic multi-period-ahead forecasts for a given time period. The memory 310, for example, stores applications, data, programs, algorithms (including software to implement or assist in implementing embodiments in accordance with the present invention) and other data.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
applying a first forecasting algorithm to historical data to generate a first forecast into a future time period n+1 when in a current time period n;
applying a second forecasting algorithm to data in the current time period n to generate a second forecast; and
combining the first and second forecasts to generate forecasts for future time periods n+k, where k is a positive integer.

2) The method of claim 1 further comprising, updating the forecasts for future time periods n+k when new data is available for the current time period n.

3) The method of claim 1, wherein the second forecast is dynamic since input data into the second forecasting algorithm is updated at intervals during the time period n.

4) The method of claim 1, wherein the first forecast is static since input data into the first forecasting algorithm does not change as new data is obtained during the time period n.

5) The method of claim 1 further comprising:
generating a confidence interval predication for the first forecast into the future time period n+1; and
using the confidence interval prediction to constrain a dynamic point prediction obtained from combining the first and second forecasts to generate the forecasts for future time periods n+k.

6) The method of claim 1 further comprising, dynamically updating the forecasts for the future time periods n+k each day during the current time period n.

7) The method of claim 1 further comprising, transmitting the forecasts for future months to a client through a web service.

8) A tangible computer readable medium having instructions for causing a computer to execute a method, comprising:
during a current time period, applying a first forecasting algorithm to static historical data to generate a first forecast into a future time period;
applying a second forecasting algorithm to dynamic data obtained for the current time period to generate a second forecast; and
combining the first and second forecasts to generate forecasts for the future time period.

9) The computer readable medium of claim 8 further comprising, dynamically updating the forecasts for the future time period each day during the current time period.

10) The computer readable medium of claim 8 further comprising:
generating an upper bound confidence interval prediction and a lower bound confidence interval prediction for the first forecast; and
using the upper and lower bound confidence interval predictions to constrain the forecasts for the future time period, wherein the upper and lower bounds provide less variability for forecasts.

11) The computer readable medium of claim 8, wherein the dynamic data is updated each day during the current time period.

12) The computer readable medium of claim 8, wherein the static data does not change as new data is obtained during the current time period.

13) The computer readable medium of claim 8, wherein the first forecasting algorithm is one of a Holt-Winter algorithm or ARIMA (Auto-Regressive Integrated Moving Average) algorithm and the second forecasting algorithm is a Bayesian algorithm.

14) The computer readable medium of claim 8, wherein the static historical data is time series data for previous months, and the first forecasting algorithm generates the first forecast for one or more future months from a current month.

15) The computer readable medium of claim 8 further comprising, updating the second forecast on an interval basis as new data is available during the current time period.

16) A computer, comprising:
a memory storing an algorithm; and
processor to execute the algorithm to:
apply a first forecasting algorithm to historical monthly data to generate a first forecast into a future month n+1 during a current month of n;
apply a second forecasting algorithm to daily data obtained during the month n to generate a second forecast; and
combining the first and second forecasts to generate forecasts for future months n+k, where k is a positive integer.

17) The computer of claim 16, wherein the processor further executes the algorithm to update the forecasts for the future months each day during a current month.

18) The computer of claim 16, wherein the processor further executes the algorithm to:
generate an upper bound confidence interval prediction and a lower bound confidence interval prediction for the first forecast; and
use the upper and lower bound confidence interval predictions to constrain the forecasts for the future months n+k.

19) The computer of claim 16, wherein the historical monthly data is time series data for previous months, and the first forecasting algorithm generates the first forecast for one or more future months from a current month.

20) The computer of claim 16, wherein, the first forecasting algorithm is one of a Holt-Winter algorithm or ARIMA (Auto-Regressive Integrated Moving Average) algorithm and the second forecasting algorithm is a Bayesian algorithm.
